(19) United States
(12) Patent Application Publication
(10) Pub. No.: US 2016/0253707 A1
(43) Pub. Date: Sep. 1, 2016

(54) METHODS AND SYSTEMS FOR TRACKING USERS

(71) Applicant: FUEL SIGNAL, Austin, TX (US)

(72) Inventors: Zulfiqar N. Momin, Sugar Land, TX (US); Ahmed Moledina, Austin, TX (US)

(21) Appl. No.: 14/625,668

(22) Filed: Feb. 19, 2015

Related U.S. Application Data
(60) Provisional application No. 61/941,641, filed on Feb. 19, 2014.
(60) Provisional application No. 61/944,249, filed on Feb. 25, 2014.

(51) Int. Cl. G06Q 30/02; G01C 21/34

(52) U.S. Cl. CPC G06Q 30/0266; G06Q 30/0275; G06Q 30/0256; G01C 21/34

(57) ABSTRACT

Embodiments disclosed herein provide systems and methods for tracking users over a geographic area and generating a meaningful display of data. The meaningful display of data may be used by retailers to transmit coupons to the users. In embodiments, vehicles' fuel levels and locations may be determined, and vehicles having a fuel level below a fuel threshold may be represented as data points on a heat map.

### CROSS-REFERENCE TO RELATED APPLICATIONS

This application claims a benefit of priority under 35 U.S.C. §119 to Provisional Application No. 61/941,641 filed on Feb. 19, 2014 and Provisional Application No. 61/944,249 filed on Feb. 25, 2014, which are fully incorporated herein by reference in their entirety.

### BACKGROUND INFORMATION

1. Field of the Disclosure

Examples of the present disclosure relate to techniques associated with tracking users. More particularly, embodiments are related to transmitting coupons and notifications based on vehicle's fuel level, locations, and driving routes.

2. Background

A heat map is a graphical representation of data where values are displayed as colors on a map. There are different types of heat maps, such as web heat maps that display areas of web pages that are most frequently scanned by visitors, population heat maps that display population densities over a geographic area, etc.

Bidding refers to techniques where a retailer may submit a bid for a task to be completed. There are different types of bidding systems, such as real time bidding where companies dynamically set bids for a task to be completed in real time, and the company with the highest bid is awarded the task to be completed. In conventional advertisement bidding systems, retailers dynamically set a price for a bid, and if the retailer has a winning bid, the retailer's advertisement may be presented to a user on a webpage.

However, situations may arise where the retailers desire to change their bids based on various data points, but the retailers do not have access to a meaningful representation of information to set their bids.

Accordingly, needs exists for more efficient and effective systems and methods for tracking users to generate a heat map, receiving bids from retailers based on the heat map, and transmitting notifications based on the bids.

### SUMMARY

Embodiments disclosed herein provide systems and methods for tracking users over a geographic area to generate a meaningful display of data. The meaningful display of data may be used by retailers to transmit notifications, coupons, promotions, etc. (referred to hereinafter collectively and individually as “coupons”) to the users. In embodiments, fuel levels of vehicles in a geographic area may be determined, and vehicles having a fuel level below a fuel threshold may be represented as data points over the geographic area.

Utilizing the data points, a heat map may be generated and a retailer may be presented with information associated with how many vehicles have a fuel level below the fuel threshold over a geographic area. The low fuel threshold may be any desired volume of fuel or an estimate indicating when vehicles will have the low fuel metric based on the vehicle's current fuel level, vehicles driving patterns over a given time period, or the user's previous purchasing history.

Responsive to the data points over the geographic area, retailers may determine bids for coupons. The coupons may be associated with a discount for fuel offered by the retailer to the users having low fuel in the geographic area and/or be cross promotion coupons for goods and/or services carried by the retailer, such as beer, soda, chips, cigarettes, etc. to promote a higher margin of sales. Responsive to receiving bids, a server may transmit coupons to users, wherein the coupons are associated with the bids.

In embodiments, the heat map may be based on data associated with vehicles' fuel level over a geographic area, the vehicles' location, and routes that vehicles' may take. The heat map may be generated in real time or as a prediction of the vehicles' future location and fuel level based on the vehicle's current fuel level, route information, and vehicle information (e.g. the vehicles' average fuel consumption on streets and highways, weather information, traffic information, etc.).

Embodiments may determine when a vehicle will be low on fuel, and determine when a user of the vehicle will refuel the vehicle. Responsive to the determining that the vehicle may become low, the vehicle's route, a coupon may be transmitted to the user. For example, if it is determined that a user cannot complete a route or a round trip route without running low on fuel or having a fuel level fall below a fuel threshold, then a coupon may be transmitted to the user before the user starts the route or while the user is on the route.

Additionally, embodiments may be configured to determine the user's purchasing history to determine when the user may desire to visit a retailer. Responsive to the determining that the user may purchase a good and/or service, a coupon may be transmitted to the user based on the user's location and purchasing history.

In embodiments, to determine a potential timing and location of when a vehicle may be low on fuel, vehicle metrics associated with the level of the fuel within the vehicle may be received and the vehicle's route or upcoming route may be determined. The route may be determined based on the vehicle's route history, inputs to define a route received from a user, vehicle speed, distance available to travel based on the vehicle's remaining fuel, gas retailers that the user frequently visits, previous behavior of user/driver, traffic, weather, etc.

In embodiments, bids from retailers may be received, wherein the bids are associating with transmitting coupons to the users in a geographic area. The bids may be received from the retailers in real-time or based on a prediction of vehicles future locations and fuel levels. The bids may be dynamically generated by the retailers or based on business rules associated with the heat map. For example, a business rule may be associated with determining that when there are at least a certain number of vehicles in a geographic area, then a bid of a first amount may be transmitted. A second business rule may be associated with when determining at least a certain number of vehicles in a geographic area have a fuel level lower than a fuel threshold, then a bid of a second amount may be transmitted. Responsive to receiving bids, a server may determine if coupons should be transmitted to users.

A retailer's bid may be a price to transmit coupons or may be associated with a discount for fuel, goods, and/or services carried by the retailer. A winning bid may be awarded to the retailer with the highest bid price or the highest discount within a coupon. The highest discount within the coupon may be associated with a discount of a good and/or service, transaction rates, loyalty points, etc.

In other embodiments, the bids may be reverse bids that are received from the user, wherein the bid indicates a desired price and/or discount for a good and/or service. Responsive to receiving a bid from the user, a retailer may determine if it is desired to accept a bid received from a user. Therefore, the user may able to negotiate or set the discount within a bid with the retailer. In further embodiments, the bidding system may be any known bidding system.

In further embodiments, the received bids may include a quantity of users able to redeem the promotion, a given redemption time period, etc. For example, a first retailer's bid may be a promotion for twenty vehicles to be given a ten cent per gallon discount, and a second retailer's bid may be a promotion for ten vehicles to be given fifteen cents per gallon discount.

In embodiments, a user's purchasing history may be determined as a collection of purchases by the user, including each product purchased, categories of products purchased, when and at what price each product is purchased, from what retailer each product purchased, the product purchased, what other products are purchased at the same time (e.g. from the same retailer on the same day), etc. Based on the user's purchasing history, a filtered heat map may be generated such that retailers may be able to determine a number of users that are likely to purchase a given product at a given time.

In embodiments, responsive to the user's purchasing history at a retailer or the user's movements within a retailer, an in-retailer route for the user may be determined. The in-retailer route may be a route that the user takes to purchase goods and/or services (referred to hereinafter individually and collectively as “goods”) within the retailer. The in-retailer route may be utilized to predict whether the user will purchase certain items and what aisles the user may take while shopping.

Furthermore, in-retailer routes may be utilized to generate an in-retailer heat map of users' shopping at a retailer and/or a prediction of the location and timing of the users' shopping patterns at the retailer. The in-retailer heat map and in-retailer route may be configured to be transmitted to other users that are linked to the user on at least one social networking site. Therefore, the other users that are linked to the user on at least one social networking site may receive information associated with the location of the user or predictive location of the user, wherein the location information may identify the location of the user whether the user is inside or outside a retailer.

The linked users on the at least one social networking site may also be able to view a graphical representation of a predictive heat map, the locations of the linked users, and/or locations of the linked users at a future point in time. In embodiments, a client computing device may be configured to receive information associated with other linked users' locations on the heat map, such that the user may determine the linked users' locations while traveling. For example, while a first user is traveling, a second linked user may be able to determine the first user's location and/or predictive route of travel in a future point in time.

In embodiments, responsive to the determined route and the user's purchasing history it may be determined if the user desires to visit a business retailer. Based on the determination that the user desires to visit the business retailer along the route, notifications and/or coupons may be transmitted to the user associated with the user's purchasing history. The usage of the coupons may be tracked to determine how many users redeem the coupons and react to the coupons. The tracking behavior may be analyzed based on a particular day, time of day, etc. to determine what items associated with the coupons lead to a higher sales conversion rate. Utilizing the tracking behavior and the user's purchasing history, business intelligence may be increased, allowing retailers to customize dynamic coupons and discount offerings to increase sales conversions.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts one topology for tracking users and generating a heat map based on the density of users over a geographic area, according to an embodiment.

FIG. 2 depicts a logic server, according to an embodiment.

FIG. 3 depicts a method for generating a heat map, according to an embodiment.

FIG. 4 depicts a method for generating a heat map, according to an embodiment.

FIG. 5 depicts a method for tracking a user within a retailer, according to an embodiment.

FIG. 6 illustrates a method for transmitting prediction based notifications and coupons, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein provide systems and methods for tracking users over a geographic area, and generating a meaningful display of data. The meaningful display of data may be used by retailers to transmit coupons to the users. In embodiments, vehicles' fuel levels and locations may be determined, and vehicles having a fuel level below a fuel threshold may be represented as data points on a heat map.

Utilizing the heat map, a retailer may be presented with how many vehicles have a fuel level below the fuel threshold over geographic regions, wherein the geographic regions may be a subset of a geographic area. The fuel threshold may be any desired volume of fuel based on the vehicle's current fuel level, vehicles driving patterns over a given time period, or the user's previous purchase behavior.

Additionally, the location data associated with a plurality of users may be aggregated, and the users' locations may be utilized to transmit coupons to the user that may be redeemed within a certain time period. Therefore, a retailer may utilize time based coupons that expire within a short time period, which may allow the retailer to attract more customers over a short period.

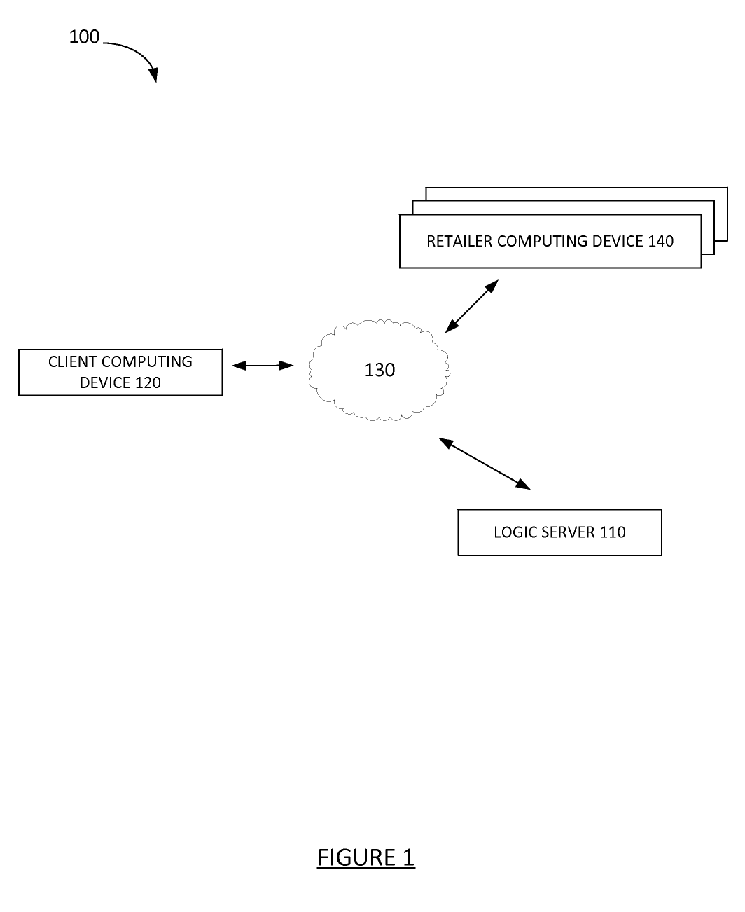

Turning now to FIG. 1, FIG. 1 depicts one topology 100 for tracking users and generating a heat map based on the density of users over a geographic area. Topology 100 may include a logic server 110, client computing device 120, a retailer computing device 140, and network 130. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Client computing device 120 may be a smart phone, tablet computer, laptop computer, a computer embedded within a vehicle, a computer coupled to a vehicle's processor and/or the vehicle's sensors, personal data assistant, or any other type of mobile device with a hardware processor that is configured to process instructions and connect to one or more portions of network 130. Client computing device 120 may be configured to determine the location of client computing device 120, receive inputs from the consumer's, set thresholds associated with initiator actions, determine if a vehicle's initiator action has been triggered, determine an amount of fuel within a vehicle's tank. Client computing device 120 may be further configured to transmit the determined information and inputs to logic server 110.

Additionally, client computing device 120 may be configured to receive notifications or coupons from retailer computing device 140 or logic server 110, and present the notifications, coupons, or promotions to the user of client computing device 120. Furthermore, a user may configure client computing device 120 to allow the user the purchase goods and/or services carried by the retailer (e.g. groceries, dry cleaning, etc.) via client computing device 120. The user may configure client computing device 120 to purchase the goods and/or services carried by the retailer based on the user's purchasing history and/or a calendar synched with client computing device 120, wherein the calendar may include dates or times to purchase the goods and/or services.

Retailer computing device 140 may be a hardware computing device that is associated with a retailer, chain of gas retailers, sets of gas retailers that are commonly owned, etc. Retailers may be any form of business or service provider such as gas stations, salons, hotels, restaurants, grocery stores, etc. Retailer computing device 140 may be configured to allow consumers to purchase fuel and other goods carried by the retailer. Retailer computing device 140 may also be configured to display a heat map corresponding to users within a geographic area, receive inputs to filter the heat map according to various factors, transmit bids to transmit notifications, and/or transmit notifications and/or coupons to users. The notifications may include information associated with the retailer, and the coupons may include discounts for goods carried by retailer. The coupons may be time sensitive coupons, such that the coupons should be used within a given time period. Additionally, the coupons may be quantity based such that only a certain number of users may redeem the coupons.

Logic server 110 may be a computing device, such as a general hardware platform server configured to support mobile applications, software, and the like executed on client computing device 120 and retailer computing device 140. Logic server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Logic server 110 may include any combination of one or more computer-usable or computer-readable media. For example, Logic server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Logic server 110 may be configured to receive information associated with vehicles' fuel levels and locations over a geographic area. Additionally, logic server 110 may be configured to present the information in a meaningful form depicting the number of vehicles within a geographic area having a fuel amount below a fuel threshold. The fuel threshold may be any desired metric associated with a volume of fuel within a vehicle's tank and/or the distance the vehicle may travel based on the current fuel level. The fuel threshold may be based on the vehicle's current fuel level, the user's driving patterns over a given time period, the type of the vehicle, the type of the road, etc.

The meaningful representation of data may be a heat map that depicts a colored representation of the density of vehicles at different geographic regions having a fuel level below a fuel threshold. The heat map may be a real-time representation of the received information or a predictive based representation a future point in time. Responsive to transmitting the heat map to retailer computing device 140, logic server 110 may be configured to receive bids to transmit coupons to the users of the vehicles having a fuel level below a fuel threshold. A retailer's bid may include a discount price, a quantity of users able to redeem the promotion, a given time period, etc.

Additionally, logic server 110 may be configured to determine if a vehicle may become low on fuel during a route. Responsive to the determining that the vehicle may become low, a coupon may be transmitted to the user, wherein the coupon may indicate a gas retailer on the given route.

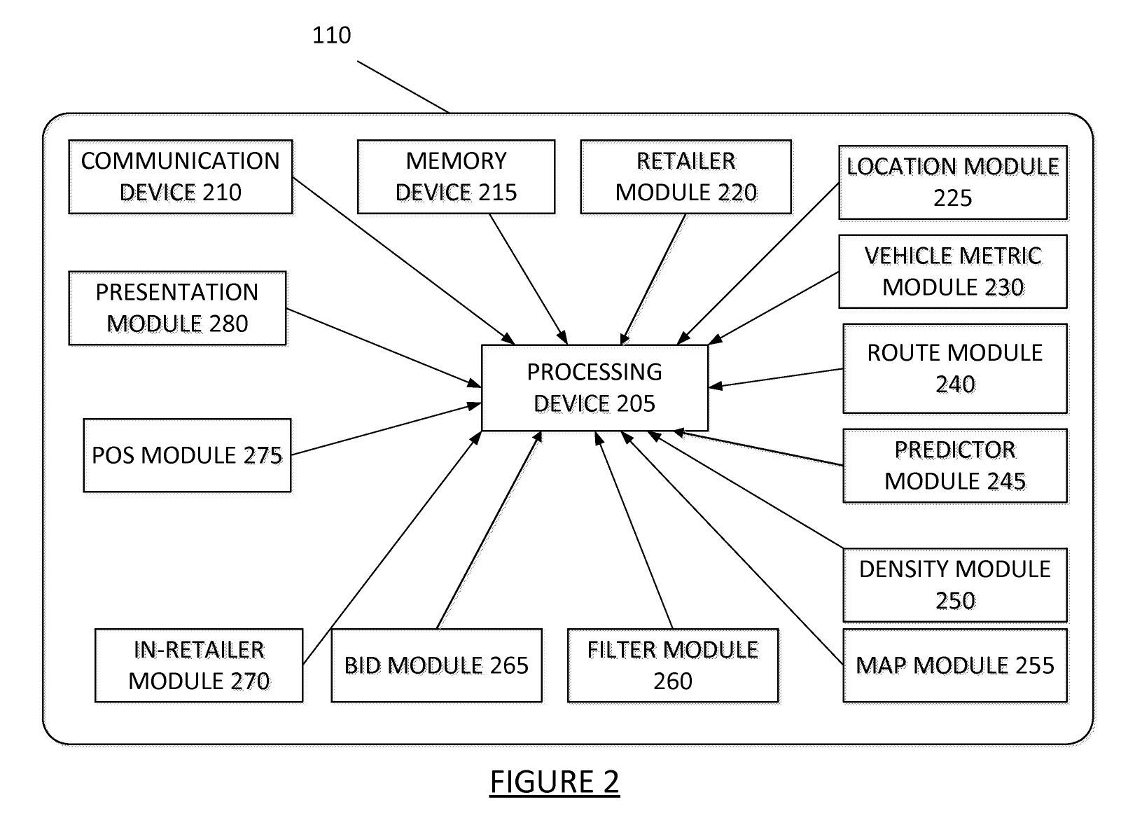

FIG. 2 depicts one embodiment of logic server 110. Logic server 110 may be configured to receive information corresponding to vehicles' fuel level over a geographic area, generate a heap map based on the number of vehicles over the geographic area having a fuel level lower than a fuel threshold, receive bids to transmit coupons to users based on the number of vehicles having a fuel level lower than the fuel threshold over the geographic area, and transmit coupons to users.

Logic server 110 may include a processing device 205, a communication device 210, a memory device 215, a retailer module 220, location module 225, vehicle metric module 230, route module 240, predictor module 245, density module 250, map module 255, filter module 260, bid module 265, in-retailer module 270, POS module 275, and presentation module 280.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of logic server 110 or software associated with other elements of logic server 110.

Communication device 210 may be a hardware processing device that allows logic server 110 to communicate with another device over a wireless or wired network, such as network 130. Communication device 210 may include one or more wireless transceivers for performing wireless communication and/or one or more communication ports for performing wired communication. Communication device 210 may be configured to communicate data over a plurality of different standard and/or protocols.

Memory device 215 may be a hardware memory device that stores data generated or received by logic server 110. Memory device 215 may include, but is not limited to a hard disc drive, an optical disc drive, and/or a flash memory drive. In embodiments, memory device 215 may be configured to store information received from client computing device 120, and retailer computing device 140. The information stored within memory device 215 may be accessed by processing device 205, communication device 210, and/or modules 220, 225, 230, 235, 240, 245, 250, 255, 260, 265, 270, 275, 280.

Retailer module 220 may be a hardware processor configured to receive retailer information from a retailer computing device 140. The retailer information may include an inventory of goods and/or services offered by the gas retailer, prices of the inventoried items (e.g. prices of fuel, prices of food within the retailer, etc.), a map of the retailer's store, and a location of the gas retailer. The map of the retailer's store may refer to a digital representation of the layout of the retailer including aisle locations and the locations of goods located at the retailer. Retailer module 220 may be configured to receive coupons from retailer computing device 140 that are configured to be transmitted to a client computing device 120. A coupon may include discounts associated with the price or goods carried by the retailers. In embodiments, the coupons may transmitted to client computing device 120 based on the location of client computing device 120, a level of fuel with the vehicle, a retailer having a winning bid to transmit coupons, the number of vehicles within a geographic area having a level of fuel below a fuel threshold, and/or the user's purchasing history.

Location module 225 may be a hardware processing device configured to determine the location of a retailer or client computing device 120. A location may be represented in geographic coordinates, Cartesian coordinates, e.g., an (x, y) point on a map if the map is divided into a Cartesian plane, and/or may be represented using reference points. In embodiments, location module 225 may determine the location of a retailer based on an employee associated with the retailer performing actions to enter location information for the retailer. The location information may be subsequently transmitted to logic server 110. Responsive to receiving the location information associated with the retailer, location module 225 may store the location information within a corresponding entry for the retailer within a database within memory device 215.

Location module 225 may also be configured to determine the location of client computing device 120 responsive to receiving location information from client computing device 120 or responsive to transmitting requests for location information to client computing device 120. In embodiments, location module 225 may be configured to receive the location information of client computing device 120 at set intervals, which may be any desired period of time (e.g., every 1/10^{th} of a second, every second, every minute, every ten minutes, etc.), based on the user's settings within the user's profile, responsive to the consumer performing actions on client computing device 120, or responsive to determining that an initiator action associated with a vehicle will be triggered on a route. Location module 225 may determine the location of client computing device 120 via any known means, such as a RTLS WiFi, radar, mobile device tracking, time distance of arrival (TDOA) signals, short wave radio, Bluetooth, etc. Responsive to determining the location of client computing device 120, location module 225 may store, within a corresponding entry of database within memory device 215. The location information may include a time stamp identifying the time that the location of the vehicle is determined.

Vehicle metric module 230 may be a hardware processing device configured to receive vehicle information from client computing device 120 communicatively coupled with a vehicle. In embodiments, vehicle metric module 230 may receive information associated with a vehicle's fuel level, such as a fuel metric indicating that the vehicle has a certain number of miles to travel on the current gas tank, a fuel metric indicating the number of fuel units till empty, a fuel metric indicating the maximum number of fuel units the vehicle may store (i.e., the size of the fuel tank), etc. Vehicle metric module 230 may receive the vehicle information at set intervals, which may be any desired period of time (e.g., every 1/10^{th} of a second, every second, every minute, every ten minutes, every hour, every day, a etc.), responsive to a fuel threshold for the vehicle being met, such as the vehicle has ten miles, twenty miles, fifty miles, etc. before the tank is empty, or some other action occurring, such as a low-level fuel light being activated.

Route module 235 may be a hardware processing device configured to determine routed a user may take, including routes entered by the user by the user performing actions to enter the route on a graphical user interface based on frequent routes or driving patterns taken by the user. Route module 235 may be configured to determine that a vehicle frequently takes a route based on the time of day, day of the week, and the location data associated with the time of day and day of the week. A route may include a path that a user takes to arrive at a destination and return to an origin point, such as the user's favorite points of interests, retailers, frequent routes taken, etc. A route may be defined as having a first segment and a second segment, wherein the first segment may be from an origin to a destination, and the second segment may be from the destination to the origin.

Route module 235 may be configured to determine a user's driving pattern during various time periods throughout the day. Such time periods may include lunch time, commuting to and/from work. For example, if a vehicle frequently travels (i.e. a percentage higher than a route threshold, such as 70%, 80%, 90% of the time, or a certain number of times) from a home location to a second location between 8:00 AM and 9:00 AM Monday through Friday, frequent route module 235 may determine that the vehicle will frequently take the route during that time period. More specifically, the first segment of the route may begin in the morning (e.g. 8:00 AM-9:00 AM) and is from the user's home to place of work, and the second segment may begin in the afternoon (e.g. 5:00 PM-6:00 PM) and may be from the user's place of work to home. A second route may be associated with places where the user eats during a lunch period. A third route may be associated with business trips that the user takes. One skilled in the art will appreciate that there may be many different routes that a user may commonly take at various time periods, and routes may be also entered by a user on client computing device 120.

Profile module 240 may be a hardware processing device configured to create a profile for the user. The user's profiles may include user information, vehicle information, and the consumer's purchasing history.

The user information may include for example, information identifying users (e.g., a username or handle, a number, an identifier, and/or other identifying information), security login information (e.g., a login code or password), payment information (e.g., credit card information), loyalty rewards cards, demographic information associated with users, driving style information associated with the user, or any other information associated with the user.

The vehicle information may include information corresponding to the vehicle, such as the vehicle's make or model, the vehicle's average mileage on a highway or standard road, a vehicle's maximum capacity for fuel, etc. The vehicle information may also include initiator actions associated with when a level of fuel within the vehicle is low. The initiator actions may be defaults such as when the vehicle's low fuel light is triggered, the vehicle has a certain distance to travel before empty, or there are a certain number of gallons of fuel within the vehicles tank before empty. The initiator actions may be set by the user, such that the user may define the certain number of gallons within the tank or the driving distance associated. The vehicle information may also include information associated with a user's driving over different routes, including the average speed that a user takes over a certain route at given times.

The purchasing history may include information associated with a user's shopping habits, which may be utilized to determine when a user may desire to receive a notification or coupon associated with a retailer's goods. The purchasing history may be a collection of purchases, including each product purchased, categories of products purchased, when and at what price each product is purchased and from what retailer, what other products are purchased at the same time (e.g. from the same retailer on the same day). This collection may be aggregated to determine a purchase history of the retailer.

Predictor module 245 may be a hardware processing device configured to determine a vehicle's location on a route at various times and the amount of fuel that the vehicle may have at the various times. Predictor module 245 may be configured to determine a vehicle's current location based on the location information received by location module 225, and predictor module 245 may be configured to determine a vehicle's current fuel level based on the vehicle's fuel information received by vehicle metric module 230. Predictor module 245 may be configured to determine a vehicle's location at a future point in time based on the vehicle's route information received by route module 235 and the vehicle's purchasing history determined by profile module 240.

Predictor module 245 may also be configured to determine the vehicle's fuel level at the future point in time based on the route information, the user's profile information, the vehicle's information and current vehicle fuel level. For example, predictor module 245 may be configured to determine that at 8:00 AM a user is driving from his house to work based on the user's frequent routes at that time or the user may perform actions to input the route. The estimate fuel level may be determined at various time periods along the route based on the vehicle's current fuel level, an estimated miles per gallon to complete the various segments of the route, the distance of the segments of the route, the road type of the segments of the route, and the vehicle information.

Additionally, predictor module 245 may be configured to receive information associated with a vehicle's current fuel level, such as the amount of fuel within the vehicle's tank, a number of miles until the vehicle's fuel tank is empty, a fuel metric indicating the maximum number of fuel units the vehicle may store (i.e., the size of the fuel tank), etc. Responsive to the amount of fuel within the vehicle and the route that the vehicle is taking or will take, predictor module 245 may be able to determine if the vehicle may complete the route (e.g. the first route segment and the second route segment) without an initiator action being triggered and/or the vehicle becoming low on fuel. Responsive to determining that the initiator action may be triggered or the vehicle may be low on fuel while on the route, a notification and/or coupon may be transmitted to client computing device 120.

The notification and/or coupon may include information associated with the vehicle not being able to complete the route on the vehicle's current fuel level, an estimated location on the route where the vehicle may be low on fuel when an initiator action may be triggered, what time or when the vehicle may be low on fuel or an initiator action may be triggered, the segment of the route where the vehicle may run low on fuel or the initiator action may be triggered, gas retailers along the route that the vehicle can make it to on the current fuel level based on the vehicle's fuel level, directions to a gas retailer, prices of fuel at the gas retailers along the route, and/or gas retailers or chains of gas retailers along the route that the user frequently visits. The coupons may include a discount on fuel and/or goods carried by the gas retailer. In embodiments, predictor module 245 may synchronize with a user's calendar, email, etc. to determine if the user may perform an action during a given hour, day, week, etc. If the calendar, email, etc. includes information indicating that the user may perform a given action at a given time, such as determine when the user may refuel a vehicle, go grocery shopping, etc, then predictor module 245 may determine that the user may perform that action at the given time.

Density module 250 may be a hardware processing device configured to determine a number of vehicles within a geographic area and regions that have fuel level lower than the fuel threshold. Density module 250 may be configured to determine the number of vehicles within the geographic region having a fuel level lower than the fuel threshold at the current time or at a future point in time. Density module 250 may be configured to parse information determined by predictor module 245 and determine the locations and fuel levels of vehicles within a geographic area. Responsive to determining the locations and fuel levels of the vehicles within the geographic area, density module 250 may further segment the number of vehicles within low fuel within geographic regions, wherein the geographic regions may be a subset of the geographic area (e.g. a zip code area within a state).

Density module 250 may determine an aggregate number of unique vehicles having a fuel level below a fuel threshold within each geographic region in real-time, a a future point in time, or over a desired time range (e.g. the current time until one hour in the future, between 5:00 PM-6:00 PM, etc.).

Additionally, based on the purchasing history of users within the geographic area, density module 250 may be configured to determine the number of users within the geographic regions that may purchase goods and/or services in real time, a point in the future, or a desired time range. Density module 250 may also be configured to further segment the users' purchasing history based on type of good and/or service purchase, brand of good and/or service purchased, etc. Density module 250 may also be configured to determine a number of users within the geographic regions that perform searches on a search index and/or application for a category of goods and/or services in real-time. For example, during a lunch hour, density module 250 may determine a number of users that are searching for a food or restaurant category.

Map module 255 may be a hardware processing device configured to receive a map of a geographic area. A geographic area may include a plurality of segments of roads, retailers, vehicles, etc. The geographic area may be segmented into a plurality of distinct geographic regions, such as zip codes, user defined regions, user defined geographic regions (e.g. an area that a retailer would attract customers from), default geographic regions, aisles of a retailer, etc. Map module 255 may also be configured to generate a heat map over the geographic regions based on the density information determined by density module 255. Specifically, geographic regions with different densities of vehicles or users may be presented in different colors, shades, textures, etc. In embodiments, a first color may represent a higher density of vehicles or users, and a second color may represent a lower density of vehicles or users. The colors, shades, textures, etc. may be chosen as a matter of design choice, where each color, shade, texture, etc. may represent a density range.

Filter module 260 may be a hardware processing device configured to receive data, wherein the received data may be utilized to filter the heat map generated by map module 255. Filter module 260 may be configured to receive information to set the fuel threshold level, such that vehicles having a fuel level less than the fuel threshold may be represented within the heat map, while vehicles having a fuel level greater than the fuel threshold may not be represented in the heat map. Filter module 260 may determine or set the fuel threshold level as any desired amount of fuel or any other factor associated with a vehicle's fuel level, such as the remaining amount of fuel within the vehicle, the distance a vehicle can travel on the vehicle's fuel level, the low fuel light is initiated within a vehicle, etc. Filter module 260 may also be configured to determine a density number of vehicles associated with the number of vehicles within a geographic area or region having a fuel level lower than the fuel threshold. Filter module 260 may also be configured to filter the heat map based on the time of day, day of the week, seasons, average densities over a time period, etc. The configuration of the filters may be utilized to establish a set of business rules for a retailer. For example, at a second segment of a day the fuel threshold may be a first value and the density number may be a second value, and at a second segment of the day the fuel threshold may be a third value and the density number may be a fourth value. Filter module 260 may also be configured to filter the heat map based on users' purchasing history, search history, a user's synched calendar, such as types of goods and/or services purchased, locations of goods and/or services purchased, brands of goods and/or services purchased, etc. over different time periods.

Bid module 265 may be a hardware processing device configured to receive bids from retailers to transmit coupons to client computing device 120. Additionally, bid module 265 may be configured to transmit coupons. The bids may be received from the retailers in real-time based on the number of vehicles within a geographic area or region having a fuel level lower than the fuel threshold, or based on the prediction of the future locations of vehicles within a geographic area or region having a fuel level lower than the fuel threshold. The received bids may include a quantity of users able to redeem the promotion, a given time period, etc. For example, a first retailer's bid may be a promotion for twenty vehicles to be given a ten cent per gallon discount and a second retailer's bid may be a promotion for ten vehicles to be given fifteen cents per gallon discount.

In embodiments, the bids may be received in real-time, the bids may be received for future periods of time, or the bids may be dynamically based on business rules set by retailers (e.g. if the heat map indicates that there will be ten or more vehicles with a fuel level lower than the fuel threshold over a given time range for a given geographic region, transmit a bid for a discount of fuel for ten cents, if the heat map indicates that there will be twenty or more vehicles with a fuel level lower than the fuel threshold over a given time range for a given geographic region, transmit a bid for a discount of fuel for twenty cents, etc.). One skilled in the art will realize that multiple geographic areas may receive different bids for different goods and/or services. For example, there may be a first bidding category associated with low fuel and a second bidding category associated with groceries purchased.

In embodiments, the winning bid may be awarded to the retailer with the highest bid price to transmit coupons or the highest discount. The retailer with the highest bid for a geographic area or region for a time period or range will be awarded the opportunity to transmit coupons to the vehicles having a fuel level lower than the fuel threshold within the corresponding area or region. A retailer's bid may be a price to transmit coupons or may be a discount for fuel, goods, and/or services carried by the retailer. In further embodiments, the winning bid may be determined a winning bid via any known bidding system, wherein the winning bid may be associated with the highest discount, number of rewards or loyalty points given to a consumer, lower transaction rates, lower interest rates for payment via a card, etc. Winning bids may be for a geographic area or for a geographic region, such that there may be a plurality of winning bids at a given time for different geographic regions.

In-retailer module 270 may be a hardware processing device configured to determine and track a user's activity within a retailer. Responsive to determining a user is at a retailer based on the location data associated with the retailer and the location data associated with the retailer, In-retailer module 270 may be configured to track the user's movements within the retailer to create a retailer profile for the user. The route that the user may take may be from an entrance within the retailer, a path along an aisle within the retailer to the location of a first good, a path along a second aisle to a location of a second product, a path to a checkout station, and a path to an exit point of the retailer. Furthermore, in-retailer module 270 may be configured to determine a route that the user may take when shopping for goods and/or services within the retailer based on the user's previous routes taken within the retailer and the user's purchasing history. Responsive to a user's previous routes within a retailer and/or route currently take within a retailer, coupons may be transmitted to the user, wherein the coupons may be associated with goods and/or services on the user's purchasing history or the user's route within the retailer.

POI module 275 may be a hardware processing device configured to receive POI information associated with gas retailers, business retailers, and/or other POIs that the user desires to receive or desires not to receive notifications and coupons from. In embodiments, the POI information may be received from client computing device 120 responsive to the user performing actions to enter the POI information on client computing device 120. The POI information may also be determined based on retailers that the user frequently visits, searches for on search indices, etc., which may be based on the user's purchasing history. If the user frequently visits a retailer (e.g. the user has visited the retailer more than a set number of times over a given time period), searches for a retailer, or searches for a category of retailer, then the retailer may be added as a frequently visited retailer. In further embodiments, the POI information may be time based, such that a retailer may be frequently visited or searched for retailer at a given time (e.g. between 11:00 AM and 1:00 PM) in the morning, in the evening, on weekdays, on weekends, etc. In further embodiments, the POI information may be associated with a chain of retailers or category of retailers, such as: Shell gas stations, Marriot hotels, Walmart, food, clothing venders, etc.

Presentation module 275 may be a hardware processing device configured to transmit information to be displayed on a display coupled with a user interface of client computing device 120. The transmitted information may be associated with coupons, wherein the coupons may be associated with a retailer with a winning bid.

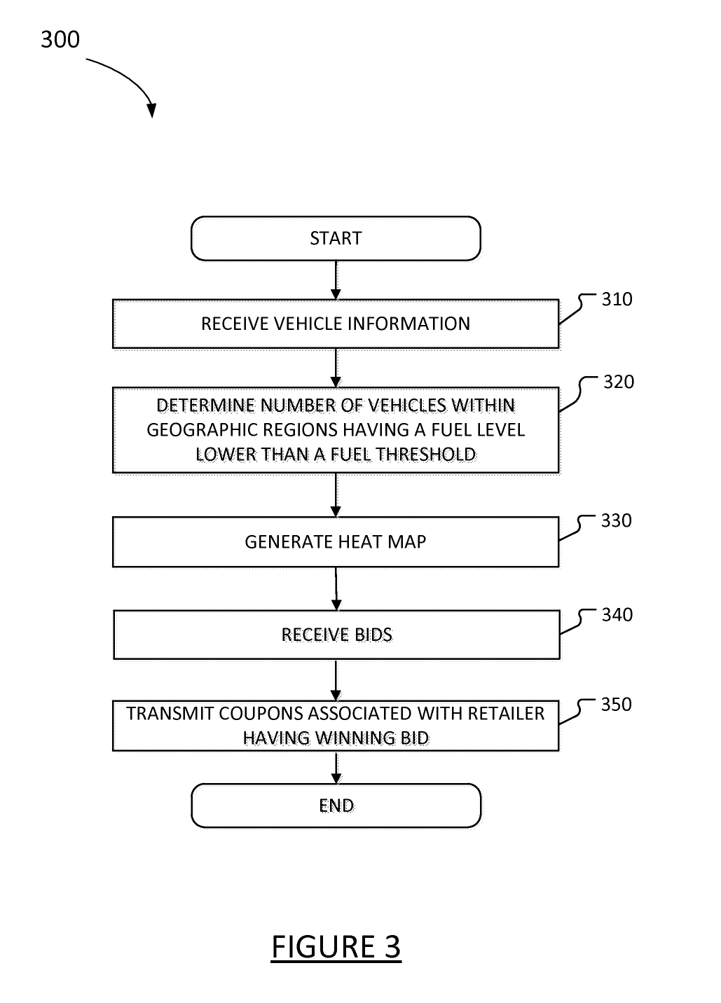

FIG. 3 illustrates a method 300 for generating a heat map. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, information associated with vehicles' fuel levels and locations may be received. Operation 310 may be performed by a location module and vehicle metric module that are the same as or similar to location module 225 and vehicle metric module 230, in accordance with one or more implementations.

At operation 320, the number of vehicles within geographic regions having a fuel level lower than a fuel threshold may be determined, wherein the geographic regions are subsets of a geographic area. Operation 320 may be performed by a density module that is the same as or similar to density module 250, in accordance with one or more implementations.

At operation 330, a heat map may be generated for the geographic area based on the number of vehicles within the geographic regions having a fuel level lower than the fuel threshold. The heat map may include different colors, shadings, or textures for the different geographic regions, wherein different colors, shadings, or textures may represent different ranges of numbers of vehicles within the geographic regions having fuel levels lower than the fuel threshold. Operation 330 may be performed by a map module that is the same as or similar to map module 255 in accordance with one or more implementations.

At operation 340, bids to transmit coupons to vehicle's having fuel levels lower than the fuel threshold within geographic regions may be received. The bids may be received from the retailers in real-time based on the number of vehicles within a geographic area or region having fuel levels lower than the fuel threshold. A winning bid may be determined based on the retailer within a region or area having the highest bid price to transmit coupons, the highest discount associated with a coupon, most rewards to the user, etc. Operation 340 may be performed by a bid module that is the same as or similar to bid 265, in accordance with one or more implementations.

At operation 350, coupons associated with a retailer having a winning bid may be transmitted. The coupons may be transmitted to vehicles within a geographic area or geographic region having fuel levels lower than the fuel threshold. Operation 350 may be performed by a presentation module that is the same as or similar to presentation module 275 and notification module 260, in accordance with one or more implementations.

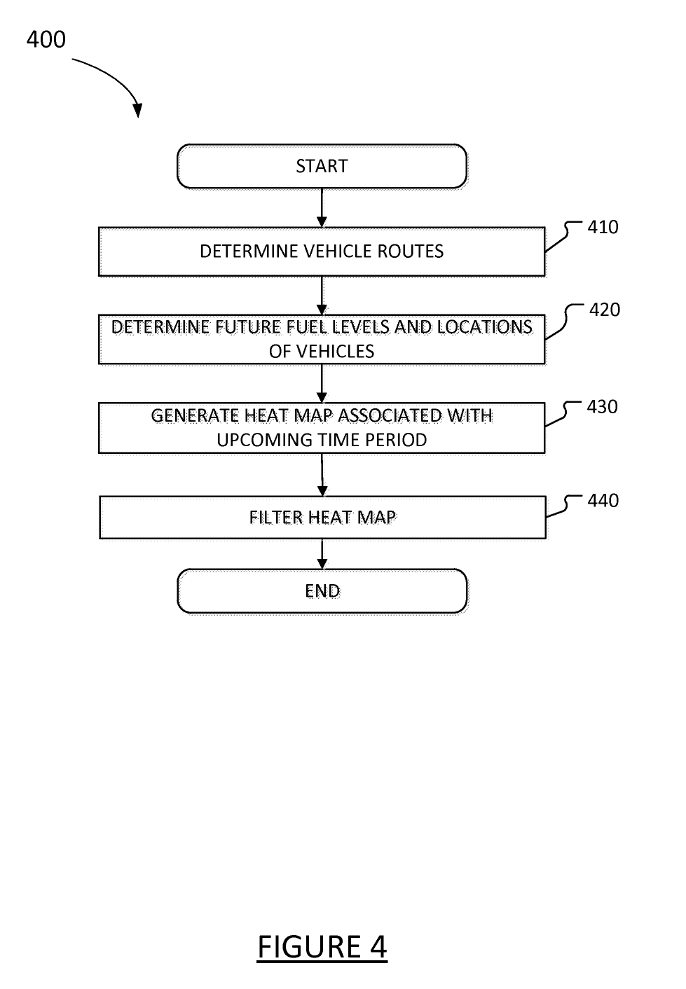

FIG. 4 illustrates a method 400 for generating a heat map. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, routes that vehicles within a geographic area are taking may be determined. The routes may be determined based on users performing actions on client computing devices to enter routes, or based on users' driving history and time of day or week. Operation 410 may be performed by a route module that is the same as or similar to route module 235, in accordance with one or more implementations.

At operation 420, the fuel levels and locations of vehicles within the geographic area at a future point in time or time range may be determined. The locations of the vehicles at the future point in time or time range may be determined based on the determined route, and the fuel levels of the vehicles at points on the route on the route, the vehicles' current fuel levels, vehicle information, and/or a user's driving profile over the route. Operation 420 may be performed by a predictor module that is the same as or similar to predictor module 245, in accordance with one or more implementations.

At operation 430, a heat map may be generated. The heat map may be generated based on the vehicles' estimated fuel levels and locations. Geographical regions within a geographical area may be presented in different colors, shades, textures, etc. based on the number of vehicles within a given geographic region having a level of fuel lower than a fuel threshold. Operation 430 may be performed by a map module that is the same as or similar to map module 255, in accordance with one or more implementations.

At operation 440, the heat map may be filtered. The heat map may be filtered to present different time periods or different ranges of time. Furthermore, the fuel threshold may be adjusted such that the number of vehicles within a given geographic region having a level of fuel lower than the fuel threshold may increase or decrease. The fuel threshold may be adjusted by changing an attribute associated with the fuel threshold. For example, the fuel threshold may be changed to be a level of fuel within the vehicle, a number of miles until a vehicle's tank is empty, or a low fuel level light is triggered. The heat map may also be filtered to change the geographic area and/or geographic regions. Operation 440 may be performed by a filter module that is the same as or similar to filter module 260, in accordance with one or more implementations.

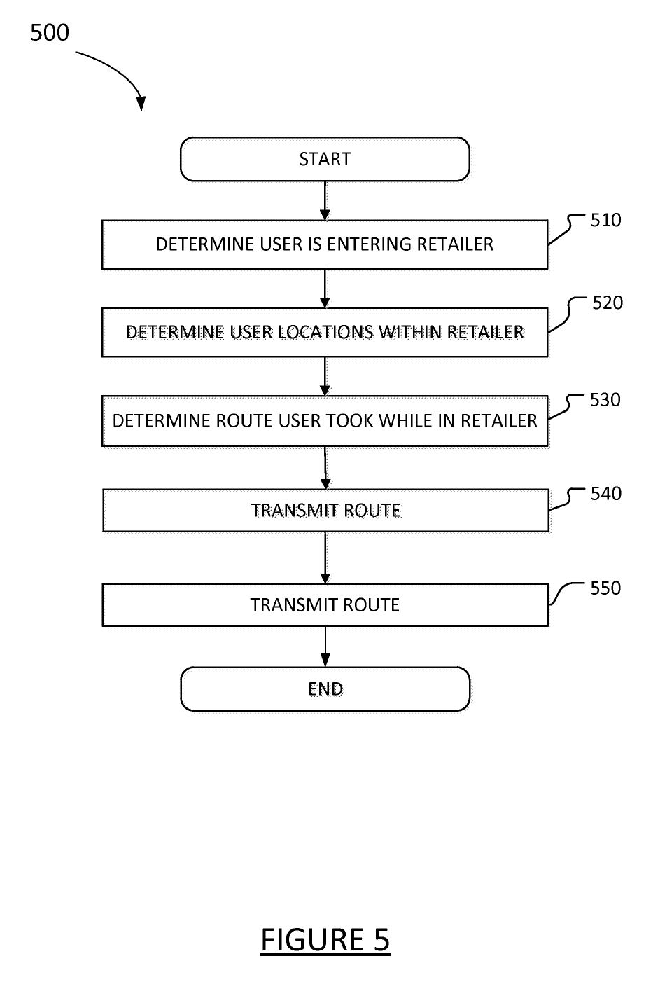

FIG. 5 illustrates a method 500 for tracking a user within a retailer. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, it may be determined that a user is entering a retailer's store. It may be determined that a user is entering a retailer's store based on the location data associated with the user and the retailer. If the location data associated with the user matches or is proximate to the location data associated with the retailer then it may be determined that the user is entering the retailer's store. Operation 510 may be performed by a location module that is the same as or similar to location module 225, in accordance with one or more implementations.

At operation 520, location information may be received identifying the consumer's location within the retailer's store. The location information may be received at set intervals, which may be any desired period of time (e.g., every 1/10^{th} of a second, every second, every minute, every ten minutes, etc.), based on the user's settings within the user's profile, responsive to the consumer performing actions on a client computing device. Operation 520 may be performed by a location module that is the same as or similar to location module 225, in accordance with one or more implementations.

At operation 530, a route that the user takes while inside the retailer may be determined based on the location information received while the user is inside the retailer. The route may include the amount of time the user took within the retailer, the number of times the user stopped within the retailer, and/or the amount of time the user spent at each stop. Operation 530 may be performed by a location module that is the same as or similar to location module 225, in accordance with one or more implementations.

At operation 540, the route that the user took while inside the retailer may be transmitted. Operation 540 may be performed by a presentation module that is the same as or similar to presentation module 275, in accordance with one or more implementations.

At operation 550, transmit coupons to the user based on the user's route within the store and goods positioned along the route. Accordingly, while a user is shopping within a retailer, relevant coupons may be transmitted to the user, such that the coupons transmitted the user are associated with goods the user may view while within the retailer. Operation 550 may be performed by a presentation module that is the same as or similar to presentation module 275, in accordance with one or more implementations.

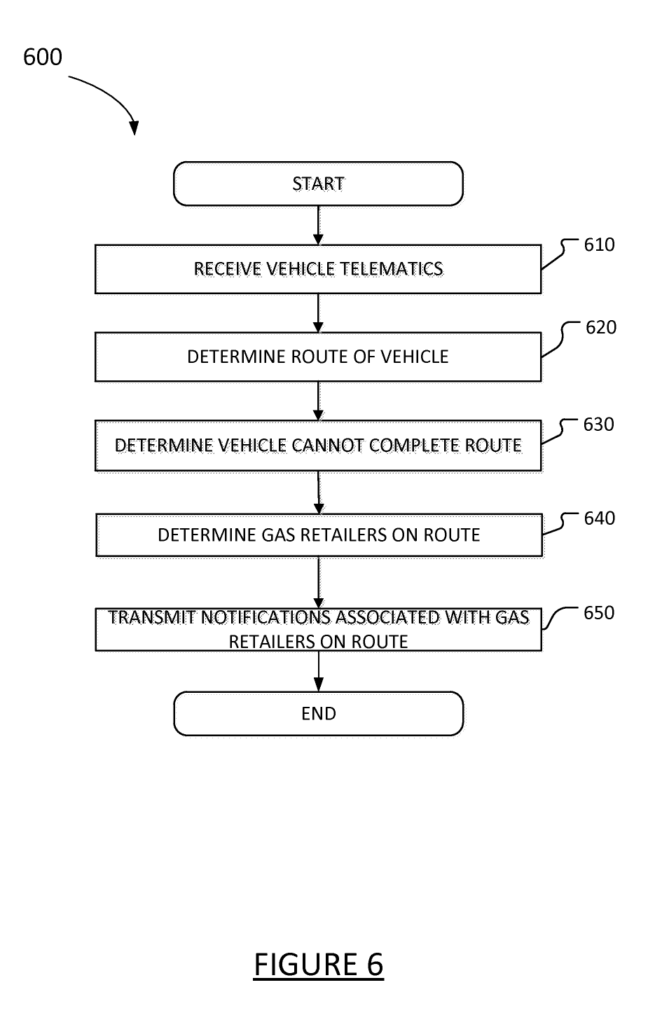

FIG. 6 illustrates a method 600 for transmitting prediction based notifications and coupons. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At operation 610, vehicle telematics associated with a vehicle may be received. The vehicle telematics may be associated with an amount of fuel within the vehicle, such as the remaining number of gallons of fuel within the vehicle's fuel tank, the number of miles until the vehicle's tank is on empty, the number of miles until an initiator action is triggered, etc. The amount of fuel within the vehicle may be determined by at least one sensor embedded within or communicatively coupled to a fuel tank of the vehicle. Operation 610 may be performed by a predictor module that is the same as or similar to predictor module 245, in accordance with one or more implementations.

At operation 620, a route that the vehicle is taking or will take is determined. The route may include a first segment and a second segment, wherein the first segment may be from an origin to a destination, and the second segment may be from the destination to the origin or a second destination. The route may be determined based on a user's driving history based on the time of day, day of the week, origin point, direction the driver is taking, etc. or may be determined by the user entering the route on a client computing device. Operation 620 may be performed by a route module that is the same as or similar to route module 240, in accordance with one or more implementations.

At operation 630, it may be determined that the vehicle cannot complete the determined route (e.g. the first route segment and the second route segment) without an initiator action being triggered and/or running low on fuel. Whether or not the vehicle may complete the current route may be based on the length of the route, estimated fuel consumption on the route, traffic, weather, level of fuel in the vehicle, type of vehicle, etc. Operation 630 may be performed by a predictor module that is the same as or similar to predictor module 245, in accordance with one or more implementations.

At operation 640, gas retailers located along the route may be determined. The gas retailers along the route may be determined based on the location data along the route and the location data of the route. In embodiments, gas retailers that the user prefers to visit may be determined responsive to the user's purchasing history. Operation 640 may be performed by a location module that is the same as or similar to location module 225, in accordance with one or more implementations.

At operation 650, notifications and/or coupons associated with the gas retailers along the route may be transmitted. The notifications and/or coupons may be associated with gas retailers that the user may arrive at when the vehicle reaches a certain fuel level or before an initiator action is triggered. The notifications and/or coupons may be transmitted for gas retailers that the user prefers to visit. The notification and/or coupons may be transmitted responsive to determining the vehicle's route, determining that the vehicle cannot complete a route, the user's purchasing history, and/or the vehicle being within a distance or time threshold of the gas retailer. Operation 650 may be performed by a fuel predictor module and notification module that are the same as or similar to predictor module 245 and notification module 260, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for tracking users and transmitting coupons, the system comprising:
a communication device configured to receive vehicle telematics associated with vehicles over a network, the vehicle telematics including information associated with fuel levels within fuel tanks of the vehicles;
a location hardware processing device configured to determine geographic regions associated with locations of the vehicles;
a density hardware processing device is configured to determine a number of vehicles having fuel levels lower than a fuel threshold within each of the geographic regions; and
a presentation hardware processing device configured to transmit coupons over the network to the vehicles having fuel levels lower than the fuel threshold, wherein the coupons are configured to be displayed on a displays associated with the vehicles.

2. The system of claim 1, further comprising:
a bid hardware processing device configured to receive bids from at least one retailer based on the number of vehicles having fuel levels lower than the fuel threshold, wherein a retailer associated with a winning bid transmits the coupons, and the coupons are associated with the retailer.

3. The system of claim 1, further comprising:
a route hardware processing device configured to determine routes that the vehicles are taking; and
a predictor hardware processing device configured to determine fuel levels and locations of the vehicles at a future point in time.

4. The system of claim 3, further comprising:
a map hardware processing device configured to generate a heat map, the heat map being based on the determined fuel levels and locations of the vehicles at the future point in time and the fuel threshold.

5. The system of claim 1, further comprising:
a profile hardware processing device configured to determine at least one of purchasing histories of users associated with the vehicles and goods searched for by the users.

6. The system of claim 5, wherein the presentation hardware processing device is configured to transmit the coupons over the network based on the purchasing histories of the users and the goods searched for by the users.

7. The system of claim 1, further comprising:
a route hardware processing device configured to determine a route of a first vehicle, wherein the first vehicle is one of the vehicles.

8. The system of claim 7, further comprising:
a predictor hardware processing device configured to determine the first vehicle cannot complete the route based on a level of fuel within the first vehicle.

9. The system of claim 8, wherein the location hardware processing device is configured to determine at least one gas retailer on the route before the level of fuel within the first vehicle falls below the fuel threshold.

10. The system of claim 9, wherein the presentation hardware processing device is configured to transmit coupons over the network to the first vehicle, wherein the coupons are associated with the at least one gas retailer.

11. A method for tracking users and transmitting coupons, the method comprising:
receiving vehicle telematics associated with vehicles over a network, the vehicle telematics including information associated with fuel levels within fuel tanks of the vehicles;
determining geographic regions associated with locations of the vehicles;
determining a number of vehicles having fuel levels lower than a fuel threshold within each of the geographic regions; and
transmitting coupons over the network to the vehicles having fuel levels lower than the fuel threshold, wherein the coupons are configured to be displayed on displays associated with the vehicles.

12. The method of claim 11, further comprising:
receiving bids from at least one retailer based on the number of vehicles having fuel levels lower than the fuel threshold, wherein a retailer associated with a winning bid transmits the coupons, and the coupons are associated with the retailer.

13. The method of claim 11, further comprising:
determining routes that the vehicles are taking; and
determine fuel levels and locations of the vehicles at a future point in time.

14. The method of claim 13, further comprising:
generating a heat map, the heat map being based on the determined fuel levels and locations of the vehicles at the future point in time and the fuel threshold.

15. The method of claim 11, further comprising:
determining at least one of purchasing histories of users associated with the vehicles and the goods searched for by the users.

16. The method of claim 15, further comprising:
transmitting the coupons over the network based on the purchasing histories of the users and the goods searched for by the users.

17. The method of claim 11, further comprising:
determining a route of a first vehicle, wherein the first vehicle is one of the vehicles.

18. The method of claim 17, further comprising:
determining the first vehicle cannot complete the route based on a level of fuel within the first vehicle.

19. The method of claim 18, further comprising:
determining at least one gas retailer on the route before the level of fuel within the first vehicle falls below the fuel threshold.

20. The method of claim 19, further comprising:
transmitting the coupons over the network to the first vehicle, wherein the coupons are associated with the at least one gas retailer.
